(19) United States
(12) Patent Application Publication
(10) Pub. No.: US 2015/0161980 A1
(43) Pub. Date: Jun. 11, 2015

(54) SYSTEMS AND METHODS FOR PROVIDING ADAPTIVE PLAYBACK EQUALIZATION IN AN AUDIO DEVICE

(71) Applicant: Cirrus Logic, Inc., Austin, TX (US)

(72) Inventors: Jeffrey D. Alderson, Austin, TX (US); Jon D. Hendrix, Wimberley, TX (US)

(73) Assignee: Cirrus Logic, Inc., Austin, TX (US)

(21) Appl. No.: 14/101,777

(22) Filed: Dec. 10, 2013

(51) Int. Cl. G10K 11/175

(52) U.S. Cl. CPC G10K 11/175

(57) ABSTRACT

In accordance with systems and methods of the present disclosure, a method may include receiving an error microphone signal indicative of an acoustic output of a transducer and ambient audio sounds at the acoustic output of the transducer. The method may also include generating an anti-noise signal to reduce the presence of the ambient audio sounds at the acoustic output of the transducer based at least on the error microphone signal. The method may further include generating an equalized source audio signal from a source audio signal by adapting, based at least on the error microphone signal, a response of the adaptive playback equalization system to minimize a difference between the source audio signal and the error microphone signal. The method may additionally include combining the anti-noise signal with the equalized source audio signal to generate an audio signal provided to the transducer.

### FIELD OF DISCLOSURE

The present disclosure relates in general to adaptive noise cancellation in connection with an acoustic transducer, and more particularly, to providing for adaptive playback equalization in an audio device.

### BACKGROUND

Personal audio devices, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events. Because the acoustic environment around personal audio devices such as wireless telephones can change dramatically, depending on the sources of noise that are present and the position of the device itself, it is desirable to adapt the noise canceling to take into account such environmental changes.

Some personal audio devices also include equalizers. Equalizers typically attempt to apply to a source audio signal an inverse of a response of the electro-acoustic path of the source audio signal through the transducer, in order to reduce the effects of the electro-acoustic path. In most traditional approaches, equalization is performed with a static equalizer. However, an adaptive equalizer may provide better output sound quality than a static equalizer, and thus, may be desirable in many applications.

### SUMMARY

In accordance with the teachings of the present disclosure, the disadvantages and problems associated with improving audio performance of a personal audio device may be reduced or eliminated.

In accordance with embodiments of the present disclosure, a personal audio device may include a personal audio device housing, a transducer, an error microphone, and one or more processing circuits. The transducer may be coupled to the housing for reproducing an output audio signal including an equalized source audio signal for playback to a listener and an anti-noise signal for countering the effects of ambient audio sounds in an acoustic output of the transducer. The error microphone may be coupled to the housing in proximity to the transducer for providing an error microphone signal indicative of the acoustic output of the transducer and the ambient audio sounds at the transducer. The one or more processing circuits may implement: a noise cancellation system that generates the anti-noise signal to reduce the presence of the ambient audio sounds heard by the listener based at least on the error microphone signal and an adaptive playback equalization system that generates the equalized source audio signal from a source audio signal by adapting, based at least on the error microphone signal, a response of the adaptive playback equalization system to minimize a difference between the source audio signal and the error microphone signal.

In accordance with these and other embodiments of the present disclosure, a method may include receiving an error microphone signal indicative of an acoustic output of a transducer and ambient audio sounds at the acoustic output of the transducer. The method may also include generating an anti-noise signal to reduce the presence of the ambient audio sounds at the acoustic output of the transducer based at least on the error microphone signal. The method may further include generating an equalized source audio signal from a source audio signal by adapting, based at least on the error microphone signal, a response of the adaptive playback equalization system to minimize a difference between the source audio signal and the error microphone signal. The method may additionally include combining the anti-noise signal with the equalized source audio signal to generate an audio signal provided to the transducer.

In accordance with these and other embodiments of the present disclosure, an integrated circuit for implementing at least a portion of a personal audio device may include an output, an error microphone input, and one or more processing circuits. The output may be configured to provide a signal to a transducer including both an equalized source audio signal for playback to a listener and an anti-noise signal for countering the effect of ambient audio sounds in an acoustic output of the transducer. The error microphone may be configured to receive an error microphone signal indicative of the output of the transducer and the ambient audio sounds at the transducer. The one or more processing circuits may implement: a noise cancellation system that generates the anti-noise signal to reduce the presence of the ambient audio sounds heard by the listener based at least on the error microphone signal and an adaptive playback equalization system that generates the equalized source audio signal from a source audio signal by adapting, based at least on the error microphone signal, a response of the adaptive playback equalization system to minimize a difference between the source audio signal and the error microphone signal.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example personal audio device, in accordance with embodiments of the present disclosure;

FIG. 1B is an illustration of an example personal audio device with a headphone assembly coupled thereto, in accordance with embodiments of the present disclosure;

FIG. 2 is a block diagram of selected circuits within the personal audio device depicted in FIG. 1, in accordance with embodiments of the present disclosure;

FIG. 3 is a block diagram depicting selected signal processing circuits and functional blocks within an example active noise canceling (ANC) circuit of a coder-decoder (CODEC) integrated circuit of FIG. 3, in accordance with embodiments of the present disclosure;

FIG. 4 is a block diagram depicting selected signal processing circuits and functional blocks within an example adaptive equalization circuit of a coder-decoder (CODEC) integrated circuit of FIG. 3, in accordance with embodiments of the present disclosure; and

FIG. 5 is a block diagram depicting selected signal processing circuits and functional blocks within an example noise injection portion of an adaptive equalization circuit of FIG. 4, in accordance with embodiments of the present disclosure.

### DETAILED DESCRIPTION

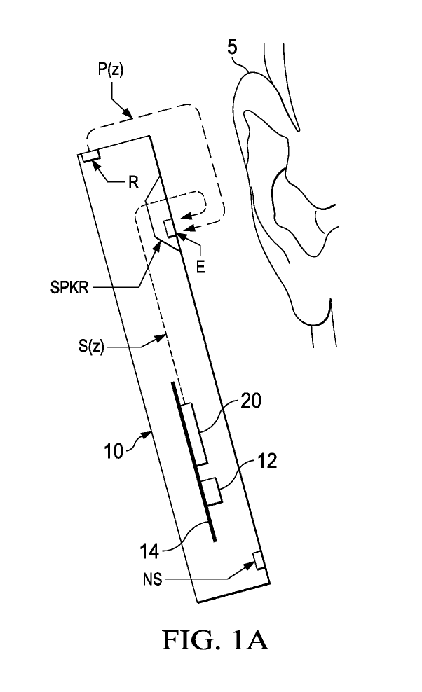

Referring now to FIG. 1A, a personal audio device 10 as illustrated in accordance with embodiments of the present disclosure is shown in proximity to a human ear 5. Personal audio device 10 is an example of a device in which techniques in accordance with embodiments of the invention may be employed, but it is understood that not all of the elements or configurations embodied in illustrated personal audio device 10, or in the circuits depicted in subsequent illustrations, are required in order to practice the invention recited in the claims. Personal audio device 10 may include a transducer such as speaker SPKR that reproduces distant speech received by personal audio device 10, along with other local audio events such as ringtones, stored audio program material, injection of near-end speech (i.e., the speech of the user of personal audio device 10) to provide a balanced conversational perception, and other audio that requires reproduction by personal audio device 10, such as sources from webpages or other network communications received by personal audio device 10 and audio indications such as a low battery indication and other system event notifications. A near-speech microphone NS may be provided to capture near-end speech, which is transmitted from personal audio device 10 to the other conversation participant(s).

Personal audio device 10 may include adaptive noise cancellation (ANC) circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when personal audio device 10 is in close proximity to ear 5. Circuit 14 within personal audio device 10 may include an audio CODEC integrated circuit (IC) 20 that receives the signals from reference microphone R, near-speech microphone NS, and error microphone E, and interfaces with other integrated circuits such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of personal audio device 10 adapt an anti-noise signal generated out the output of speaker SPKR from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to personal audio device 10, when personal audio device 10 is not firmly pressed to ear 5. While the illustrated personal audio device 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone covering detection schemes. In addition, although only one reference microphone R is depicted in FIG. 1, the circuits and techniques herein disclosed may be adapted, without changing the scope of the disclosure, to personal audio devices including a plurality of reference microphones.

Referring now to FIG. 1B, personal audio device 10 is depicted having a headphone assembly 13 coupled to it via audio port 15. Audio port 15 may be communicatively coupled to RF integrated circuit 12 and/or CODEC IC 20, thus permitting communication between components of headphone assembly 13 and one or more of RF integrated circuit 12 and/or CODEC IC 20. As shown in FIG. 1B, headphone assembly 13 may include a combox 16, a left headphone 18A, and a right headphone 18B. As used in this disclosure, the term “headphone” broadly includes any loudspeaker and structure associated therewith that is intended to be mechanically held in place proximate to a listener's ear or ear canal, and includes without limitation earphones, earbuds, and other similar devices. As more specific non-limiting examples, “headphone,” may refer to intra-canal earphones, intra-concha earphones, supra-concha earphones, and supra-aural earphones.

Combox 16 or another portion of headphone assembly 13 may have a near-speech microphone NS to capture near-end speech in addition to or in lieu of near-speech microphone NS of personal audio device 10. In addition, each headphone 18A, 18B may include a transducer such as speaker SPKR that reproduces distant speech received by personal audio device 10, along with other local audio events such as ringtones, stored audio program material, injection of near-end speech (i.e., the speech of the user of personal audio device 10) to provide a balanced conversational perception, and other audio that requires reproduction by personal audio device 10, such as sources from webpages or other network communications received by personal audio device 10 and audio indications such as a low battery indication and other system event notifications. Each headphone 18A, 18B may include a reference microphone R for measuring the ambient acoustic environment and an error microphone E for measuring of the ambient audio combined with the audio reproduced by speaker SPKR close to a listener's ear when such headphone 18A, 18B is engaged with the listener's ear. In some embodiments, CODEC IC 20 may receive the signals from reference microphone R, near-speech microphone NS, and error microphone E of each headphone and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

The various microphones referenced in this disclosure, including reference microphones, error microphones, and near-speech microphones, may comprise any system, device, or apparatus configured to convert sound incident at such microphone to an electrical signal that may be processed by a controller, and may include without limitation an electrostatic microphone, a condenser microphone, an electret microphone, an analog microelectromechanical systems (MEMS) microphone, a digital MEMS microphone, a piezoelectric microphone, a piezo-ceramic microphone, or dynamic microphone.

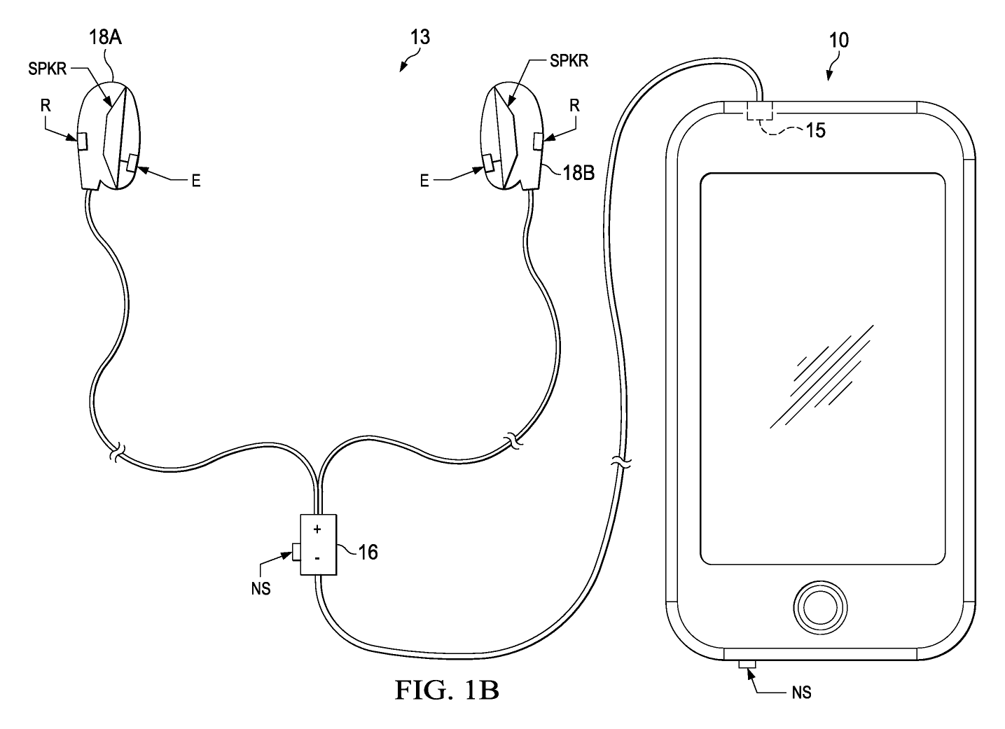

Referring now to FIG. 2, selected circuits within personal audio device 10, which in other embodiments may be placed in whole or part in other locations such as one or more headphone assemblies 13, are shown in a block diagram. CODEC IC 20 may include an analog-to-digital converter (ADC) 21A for receiving the reference microphone signal and generating a digital representation ref of the reference microphone signal, an ADC 21B for receiving the error microphone signal and generating a digital representation err of the error microphone signal, and an ADC 21C for receiving the near speech microphone signal and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine an equalized source audio signal generated by adaptive equalization circuit 40 from audio signals is from internal audio sources 24 and/or downlink speech ds which may be received from radio frequency (RF) integrated circuit 22, the anti-noise signal generated by ANC circuit 30, which by convention has the same polarity as the noise in reference microphone signal ref and is therefore subtracted by combiner 26, and a portion of near speech microphone signal ns so that the user of personal audio device 10 may hear his or her own voice in proper relation to downlink speech ds. Near speech microphone signal ns may also be provided to RF integrated circuit 22 and may be transmitted as uplink speech to the service provider via antenna ANT.

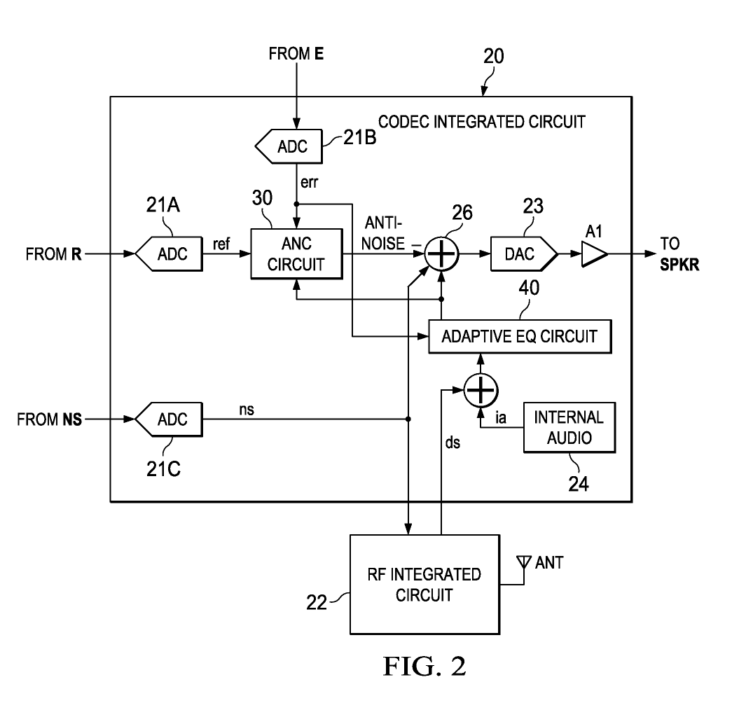

Referring now to FIG. 3, details of ANC circuit 30 are shown in accordance with embodiments of the present disclosure. Adaptive filter 32 may receive reference microphone signal ref and under ideal circumstances, may adapt its transfer function W(z) to be P(z)/S(z) to generate the anti-noise signal, which may be provided to an output combiner that combines the anti-noise signal with the audio to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and a playback corrected error, labeled as “PBCE” in FIG. 3, based at least in part on error microphone signal err. The playback corrected error may be generated as described in greater detail below.

By transforming reference microphone signal ref with a copy of the estimate of the response of path S(z), response SE_{COPY}(z) of filter 34B, and minimizing the difference between the resultant signal and error microphone signal err, adaptive filter 32 may adapt to the desired response of P(z)/S(z). In addition to error microphone signal err, the signal compared to the output of filter 34B by W coefficient control block 31 may include an inverted amount of equalized source audio signal (e.g., downlink audio signal ds and/or internal audio signal ia), that has been processed by filter response SE(z), of which response SE_{COPY}(z) is a copy. By injecting an inverted amount of equalized source audio signal, adaptive filter 32 may be prevented from adapting to the relatively large amount of equalized source audio signal present in error microphone signal err. However, by transforming that inverted copy of equalized source audio signal with the estimate of the response of path S(z), the equalized source audio that is removed from error microphone signal err should match the expected version of the equalized source audio signal reproduced at error microphone signal err, because the electrical and acoustical path of S(z) is the path taken by the equalized source audio signal to arrive at error microphone E. Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare the equalized source audio signal and a playback corrected error. The playback corrected error may be equal to error microphone signal err after removal of the equalized source audio signal (as filtered by filter 34A to represent the expected playback audio delivered to error microphone E) by a combiner 36. SE coefficient control block 33 may correlate the actual equalized source audio signal with the components of the equalized source audio signal that are present in error microphone signal err. Adaptive filter 34A may thereby be adapted to generate a secondary estimate signal from the equalized source audio signal, that when subtracted from error microphone signal err to generate the playback corrected error, includes the content of error microphone signal err that is not due to the equalized source audio signal.

Although FIGS. 2 and 3 depict a feedforward ANC system in which an anti-noise signal is generated from a filtered reference microphone signal, any other suitable ANC system employing an error microphone may be used in connection with the methods and systems disclosed herein. For example, in some embodiments, an ANC circuit employing feedback ANC, in which anti-noise is generated from a playback corrected error signal, may be used instead of or in addition to feedforward ANC, as depicted in FIGS. 2 and 3.

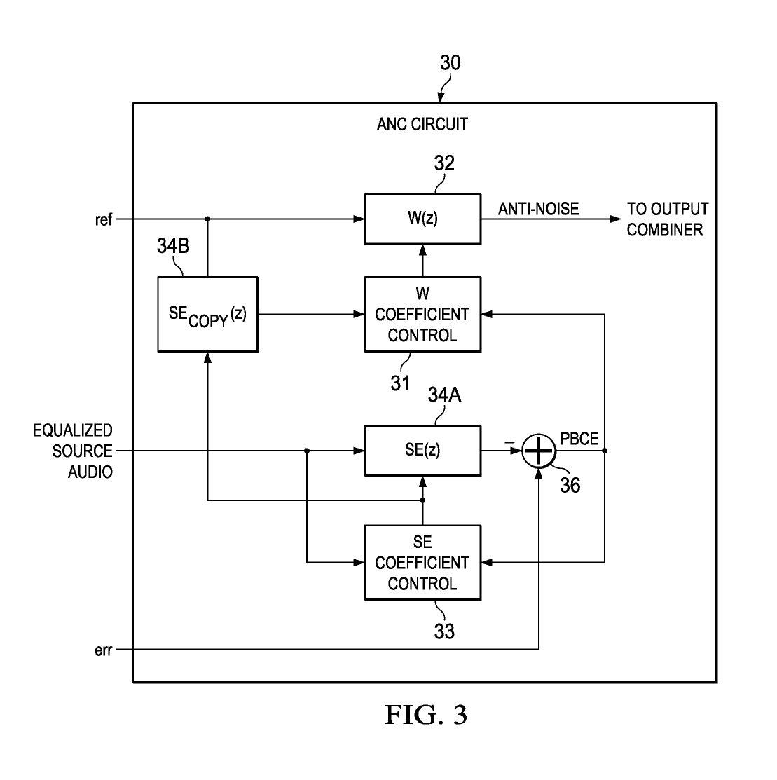

Referring now to FIG. 4, details of adaptive equalizer circuit 40 are shown in accordance with embodiments of the present disclosure. Adaptive equalization filter 42 may receive the source audio signal (e.g., downlink speech ds and/or internal audio ia) and under ideal circumstances, may adapt its transfer function EQ(z) to be Delay/S(z) (wherein Delay is a signal delay added to a signal by delay element 48, as described in greater detail below) to generate the equalized source audio signal, which may be provided to ANC circuit 30 (as described above) and provided to an output combiner that combines the anti-noise signal with the equalized source audio signal to be reproduced by the transducer, as exemplified by combiner 26 of FIG. 2. The coefficients of adaptive equalization filter 42 may be controlled by an equalizer coefficient control block 41 that uses a correlation of signals to determine the response EQ(z) of adaptive equalization filter 42, which generally minimizes the error, in a least-mean squares sense, between the delayed source audio signal and the error microphone signal err, as described in greater detail below.

To implement the above, adaptive equalization filter 42 may have coefficients controlled by equalizer coefficient control block 41, which may compare a source audio signal and a delay corrected error. The source audio signal may include downlink audio signal ds and/or internal audio signal ia. The delay corrected error may be equal to error microphone signal err after removal of the source audio signal (as delayed by a delay block 48) by a combiner 46. Equalization coefficient control block 41 may correlate the actual source audio signal with the components of the source audio signal that are present in error microphone signal err. The signals compared by equalizer coefficient control block 41 may be the source audio signal as shaped by a copy of an estimate of the response of path S(z) provided by filter 34C and a delay corrected error, based at least in part on error microphone signal err.

In some embodiments, adaptive equalization filter 42 may comprise a shelving filter, as is known in the art. In such embodiments, at least one of a pole frequency and a zero frequency of the shelving filter may be variable based on the error microphone signal.

As mentioned above, in addition to error microphone signal err, the signal compared to the output of filter 34C by equalizer coefficient control block 41 may include a delayed amount source audio signal (e.g., downlink audio signal ds and/or internal audio signal ia), that has been delayed by delay block 48. By delaying the source audio signal by at least the delay of the secondary path represented by S(z), the system formed by adaptive equalization circuit 40 may operate as a causal system.

In some embodiments, a noise injection portion 50 may inject noise into each side of equalizer coefficient control block 41, as shown in FIG. 4. For example, noise injection portion 50 may inject an x-side injected noise signal into the filtered source audio signal generated by filter 34C (e.g., by a combiner which is not explicitly shown) and an e-side injected noise signal into the delay corrected error (e.g., by combiner 46 or another combiner which is not explicitly shown).

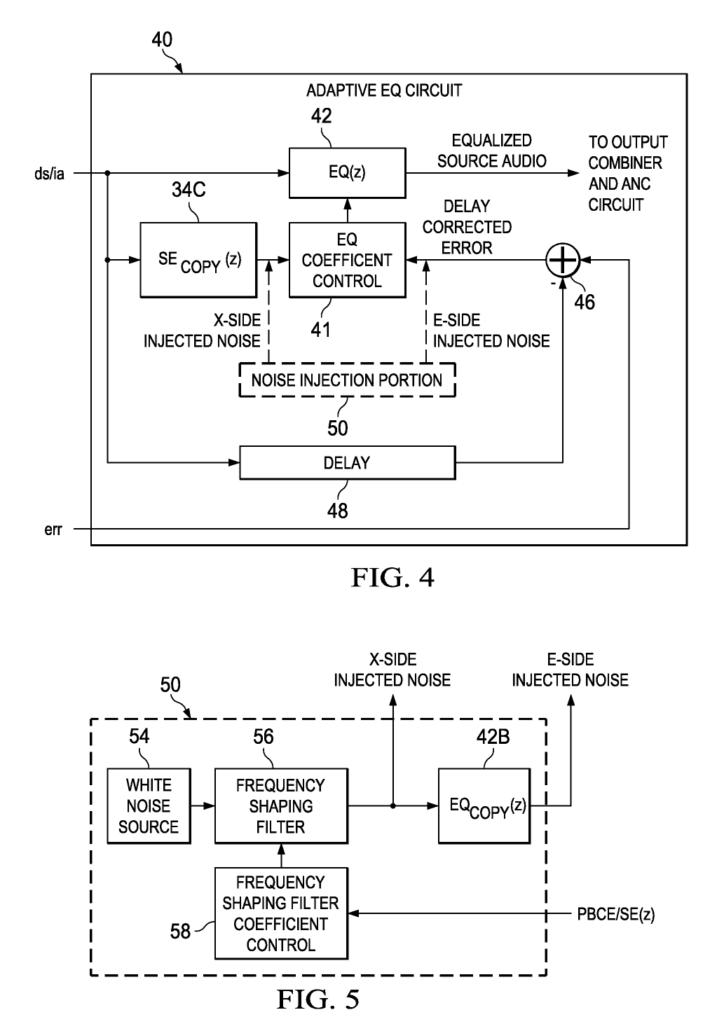

Referring now to FIG. 5, details of a noise injection portion 50, which may be present in some embodiments of adaptive equalizer circuit 40 in or are shown in accordance with embodiments of the present disclosure. Noise injection portion 50 may include a white noise source 54 for generating white noise (e.g., an audio signal with a constant amplitude across all frequencies of interest, such as those frequencies within the range of human hearing). A frequency shaping filter 56 may generate the x-side injected noise signal by filtering the white noise signal, wherein a response of the frequency shaping filter is shaped by frequency shaping filter coefficient control block 58 in conformity with the playback corrected error, response SE(z) of filter 34A, or other suitable signal or response. In some embodiments, coefficient control block 58 may implement an adaptive linear prediction coefficient system which estimates a frequency spectrum of the playback corrected error, response SE(z) of filter 34A, or other suitable signal or response received by noise injection portion 50. Accordingly, the noise signal generated by frequency shaping filter 56 may comprise the white noise signal filtered such that the white noise signal is attenuated or eliminated in those frequencies within the frequency spectrum of the playback corrected error, such that the output of frequency shaping filter 56 has a frequency spectrum with greater magnitude content at frequencies in which the playback corrected error, response SE(z) of filter 34A, or other suitable signal or response received by noise injection portion 50 is at or is substantially near zero. In these and other embodiments, noise injection portion 50 may include an adaptive equalizer filter 42B, which may be a copy of adaptive equalization filter 42, wherein adaptive equalizer filter 42B applies its response EQ_{COPY}(z) to the x-side injection noise, in order to generate the e-side injection noise signal. The injected noise signals may serve to bias, to below a predetermined maximum, a magnitude of the response of adaptive equalization filter 42 corresponding to a frequency in which the response of secondary path estimate filter 34C is substantially zero.

In addition to or alternatively to the noise injection described above, other approaches may be used in order to limit magnitudes of the response of adaptive equalization filter 42 at frequencies corresponding to nulls in the response SE(z) below a predetermined acceptable level. For example, in some embodiments, a number of coefficients of adaptive equalizer filter 42 and equalizer coefficient control block 41 may be selected in order to limit magnitudes of the response of adaptive equalization filter 42 at frequencies corresponding to nulls in the response SE(z) below a predetermined acceptable level.

In these and other embodiments, the response of adaptive equalizer filter 42 may be disabled from adapting when conditions are present that may hinder the ability of adaptive equalizer filter 42 to converge or adapt. For example, the response of adaptive equalizer filter 42 may be disabled from adapting when the spectral density of the source audio signal is lesser than a minimum spectral density. As another example, the response of adaptive equalizer filter 42 may be disabled from adapting when a transducer has been removed from a proximity of an ear of a listener (which may be determined as described in U.S. patent application Ser. No. 13/844,602 filed Mar. 15, 2013, entitled “Monitoring of Speaker Impedance to Detect Pressure Applied Between Mobile Device in Ear,” as described in U.S. patent application Ser. No. 13/310,380 filed Dec. 2, 2011, entitled “Ear-Coupling Detection and Adjustment of Adaptive Response in Noise-Cancelling in Personal Audio Devices,” or as otherwise known in the art). As an additional example, the response of adaptive equalizer filter 42 may be disabled from adapting when “clipping” may occur, as indicated by a magnitude of the audio output signal driving a transducer being within a predetermined threshold of a magnitude of a power supply for driving the output audio signal. As a further example, the response of adaptive equalizer filter 42 may be disabled from adapting when a physical displacement of a transducer is such that its displacement as a function of the output audio signal driving the transducer is substantially nonlinear.

In some embodiments, the sequencing of adaptation of response SE(z) of filter 34A and response EQ(z) of adaptive equalization filter 42 may be configured to ensure stability of adaptation of response SE(z) and response EQ(z). For example, in such embodiments, CODEC IC 20 may be configured to train response SE(z) prior to training of response EQ(z), as response EQ(z) relies on response SE_{COPY}(z) for stability. After both responses SE(z) and EQ(z) have been trained, training may alternate between the responses. As another example, CODEC IC 20 may be configured to such that response EQ(z) trains only while response SE(z) is training, again because response EQ(z) relies on response SE_{COPY}(z) for stability. As a further example, CODEC IC 20 may be configured such that response EQ(z) adapts at a slower rate than response SE(z).

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. A personal audio device comprising:
a personal audio device housing;
a transducer coupled to the housing for reproducing an output audio signal including an equalized source audio signal for playback to a listener and an anti-noise signal for countering the effects of ambient audio sounds in an acoustic output of the transducer;
an error microphone coupled to the housing in proximity to the transducer for providing an error microphone signal indicative of the acoustic output of the transducer and the ambient audio sounds at the transducer;
one or more processing circuits that implement:
a noise cancellation system that generates the anti-noise signal to reduce the presence of the ambient audio sounds heard by the listener based at least on the error microphone signal; and
an adaptive playback equalization system that generates the equalized source audio signal from a source audio signal by adapting, based at least on the error microphone signal, a response of the adaptive playback equalization system to minimize a difference between the source audio signal and the error microphone signal.

2. The personal audio device of claim 1, wherein the adaptive playback equalization system comprises:
an adaptive equalization filter having a response that generates the equalized source audio signal from the source audio signal to reduce the effects of an electro-acoustical path of the source audio signal through the transducer; and
a coefficient control block that shapes the response of the adaptive equalization filter in conformity with the error microphone signal and the source audio signal by adapting the response of the adaptive equalization filter to minimize the difference between the error microphone signal and the source audio signal.

3. The personal audio device of claim 2, wherein the adaptive equalization filter comprises a shelving filter, wherein at least one of a pole frequency and a zero frequency of the shelving filter are variable based on the error microphone signal.

4. The personal audio device of claim 2, wherein the adaptive playback equalization system further comprises a secondary path estimate filter for modeling the electro-acoustical path and having a response that generates a secondary path estimate from the source audio signal and wherein the coefficient control block shapes the response of the adaptive equalization filter in conformity with the secondary path estimate and a delay corrected error, wherein the delay corrected error is based on a difference between the error microphone signal and a delayed source audio signal.

5. The personal audio device of claim 4, wherein the one or more processing circuits implement a second coefficient control block that shapes the response of the secondary path estimate filter in conformity with the source audio signal and a playback corrected error by adapting the response of the secondary path estimate filter to minimize the playback corrected error, wherein the playback corrected error is based on a difference between the error microphone signal and the secondary path estimate.

6. The personal audio device of claim 4, wherein a number of coefficients of the coefficient control block is selected such that a magnitude of the response of the adaptive equalization filter corresponding to a frequency in which the response of the secondary path estimate filter is substantially zero is limited below a predetermined maximum.

7. The personal audio device of claim 4, wherein the one or more processing circuits implement a noise injection portion for injecting respective noise signals into the secondary path estimate and the delay corrected error in order to bias, to below a predetermined maximum, a magnitude of the response of the adaptive equalization filter corresponding to a frequency in which the response of the secondary path estimate filter is substantially zero.

8. The personal audio device of claim 1, wherein the one or more processing circuits disable the response of the adaptive playback equalization system from adapting responsive to at least one of:
a determination that a spectral density of the source audio signal is lesser than a minimum spectral density;
a determination that the transducer has been removed from a proximity of an ear of the listener;
a determination that a magnitude of the output audio signal is within a predetermined threshold of a magnitude of a power supply for driving the output audio signal; and
a determination that a displacement of the transducer is such that its displacement as a function of the output audio signal is substantially nonlinear.

9. The personal audio device of claim 1, further comprising a reference microphone coupled to the housing for providing a reference microphone signal indicative of the ambient audio sounds, wherein the noise cancellation system further comprises:
an adaptive filter having a response that generates the anti-noise signal from the reference microphone signal to reduce the presence of the ambient audio sounds heard by the listener; and
a coefficient control block that shapes the response of the adaptive filter in conformity with the error microphone signal and the reference microphone signal by adapting the response of the adaptive filter to minimize the ambient audio sounds in the error microphone signal.

10. The personal audio device of claim 1, further comprising a reference microphone coupled to the housing for providing a reference microphone signal indicative of the ambient audio sounds, wherein the noise cancellation system further comprises:
a filter having a response that generates the anti-noise signal from the reference microphone signal to reduce the presence of the ambient audio sounds heard by the listener;
a secondary path estimate adaptive filter for modeling an electro-acoustical path of the source audio signal and having a response that generates a secondary path estimate from the equalized source audio signal; and
a coefficient control block that shapes the response of the secondary path estimate adaptive filter in conformity with the equalized source audio signal and a playback corrected error by adapting the response of the secondary path estimate filter to minimize the playback corrected error, wherein the playback corrected error is based on a difference between the error microphone signal and the secondary path estimate.

11. The personal audio device of claim 10, wherein the one or more processing circuits are configured to adapt the response of the secondary path estimate adaptive filter prior to adapting the response of the adaptive playback equalization system.

12. The personal audio device of claim 11, wherein the one or more processing circuits are configured to alternate adaptation of the secondary path estimate adaptive filter and the response of the adaptive playback equalization system.

13. The personal audio device of claim 10, wherein the one or more processing circuits are configured to adapt the response of the adaptive playback equalization system only when the secondary path estimate adaptive filter is adapting.

14. The personal audio device of claim 10, wherein the one or more processing circuits are configured to adapt the response of the adaptive playback equalization system at a rate slower than the rate of adaptation of the secondary path estimate adaptive filter.

15. A method comprising:
receiving an error microphone signal indicative of an acoustic output of a transducer and ambient audio sounds at the acoustic output of the transducer;
generating an anti-noise signal to reduce the presence of the ambient audio sounds at the acoustic output of the transducer based at least on the error microphone signal;
generating an equalized source audio signal from a source audio signal by adapting, based at least on the error microphone signal, a response of an adaptive playback equalization system to minimize a difference between the source audio signal and the error microphone signal; and
combining the anti-noise signal with the equalized source audio signal to generate an audio signal provided to the transducer.

16. The method of claim 15, wherein the equalized source audio signal is generated by an adaptive equalization filter having a response that generates the equalized source audio signal from the source audio signal to reduce the effects of an electro-acoustical path of the source audio signal through the transducer, and the method further comprising shaping the response of the adaptive equalization filter in conformity with the error microphone signal and the source audio signal by adapting the response of the adaptive equalization filter to minimize the difference between the error microphone signal and the source audio signal.

17. The method of claim 16, wherein the adaptive equalization filter comprises a shelving filter, wherein at least one of a pole frequency and a zero frequency of the shelving filter are variable based on the error microphone signal.

18. The method of claim 16, further comprising generating a secondary path estimate from the source audio signal by filtering the source audio signal with a secondary path estimate filter modeling an electro-acoustical path of the source audio signal; and wherein shaping the response of the adaptive equalization filter comprises shaping the response of the adaptive equalization filter in conformity with the secondary path estimate and a delay corrected error, wherein the delay corrected error is based on a difference between the error microphone signal and a delayed source audio signal.

19. The method of claim 18, further comprising shaping the response of the secondary path estimate filter in conformity with the source audio signal and a playback corrected error by adapting the response of the secondary path estimate filter to minimize the playback corrected error, wherein the playback corrected error is based on a difference between the error microphone signal and the secondary path estimate.

20. The method of claim 18, wherein the response of the adaptive equalization filter is shaped by a coefficient control block, and a number of coefficients of the coefficient control block is selected such that a magnitude of the response of the adaptive equalization filter corresponding to a frequency in which the response of the secondary path estimate filter is substantially zero is limited below a predetermined maximum.

21. The method of claim 18, further comprising injecting respective noise signals into the secondary path estimate and the delay corrected error in order to bias, to below a predetermined maximum, a magnitude of the response of the adaptive equalization filter corresponding to a frequency in which the response of the secondary path estimate filter is substantially zero.

22. The method of claim 15, further comprising disabling the response of the adaptive playback equalization system from adapting responsive to at least one of:
a determination that a spectral density of the source audio signal is lesser than a minimum spectral density;
a determination that the transducer has been removed from a proximity of an ear of the listener;
a determination that a magnitude of the output audio signal is within a predetermined threshold of a magnitude of a power supply for driving the output audio signal; and
a determination that a displacement of the transducer is such that its displacement as a function of the output audio signal is substantially nonlinear.

23. The method of claim 15, further comprising:
receiving a reference microphone signal indicative of the ambient audio sounds; and
generating the anti-noise signal from filtering the reference microphone signal with an adaptive filter to reduce the presence of the ambient audio sounds heard by the listener by shaping the response of the adaptive filter in conformity with the error microphone signal and the reference microphone signal by adapting the response of the adaptive filter to minimize the ambient audio sounds in the error microphone signal.

24. The method of claim 15, further comprising:
receiving a reference microphone signal indicative of the ambient audio sounds;
generating the anti-noise signal from the reference microphone signal to reduce the presence of the ambient audio sounds heard by the listener;
generating a secondary path estimate from the equalized source audio signal by filtering the equalized source audio signal with a secondary path estimate filter modeling an electro-acoustical path of the source audio signal; and
shaping the response of the secondary path estimate filter in conformity with the equalized source audio signal and a playback corrected error by adapting the response of the secondary path estimate filter to minimize the playback corrected error, wherein the playback corrected error is based on a difference between the error microphone signal and the secondary path estimate.

25. The method of claim 24, wherein the response of the secondary path estimate adaptive filter adapts prior to adaptation of the response of the adaptive playback equalization system.

26. The method of claim 25, further comprising alternating adaptation of the secondary path estimate adaptive filter and the response of the adaptive playback equalization system.

27. The method of claim 24, further comprising adapting the response of the adaptive playback equalization system only when the secondary path estimate adaptive filter is adapting.

28. The method claim 24, further comprising adapting the response of the adaptive playback equalization system at a rate slower than the rate of adaptation of the secondary path estimate adaptive filter.

29. An integrated circuit for implementing at least a portion of a personal audio device, comprising:
an output for providing a signal to a transducer including both an equalized source audio signal for playback to a listener and an anti-noise signal for countering the effect of ambient audio sounds in an acoustic output of the transducer;
an error microphone input for receiving an error microphone signal indicative of the acoustic output of the transducer and the ambient audio sounds at the transducer; and
one or more processing circuits that implement:
a noise cancellation system that generates the anti-noise signal to reduce the presence of the ambient audio sounds heard by the listener based at least on the error microphone signal; and
an adaptive playback equalization system that generates the equalized source audio signal from a source audio signal by adapting, based at least on the error microphone signal, a response of the adaptive playback equalization system to minimize a difference between the source audio signal and the error microphone signal.

30. The integrated circuit of claim 29, wherein the adaptive playback equalization system comprises:
an adaptive equalization filter having a response that generates the equalized source audio signal from the source audio signal to reduce the effects of an electro-acoustical path of the source audio signal through the transducer; and
a coefficient control block that shapes the response of the adaptive equalization filter in conformity with the error microphone signal and the source audio signal by adapting the response of the adaptive equalization filter to minimize the difference between the error microphone signal and the source audio signal.

31. The integrated circuit of claim 30, wherein the adaptive equalization filter comprises a shelving filter, wherein at least one of a pole frequency and a zero frequency of the shelving filter are variable based on the error microphone signal.

32. The integrated circuit of claim 30, wherein the adaptive playback equalization system further comprises a secondary path estimate filter for modeling the electro-acoustical path and having a response that generates a secondary path estimate from the source audio signal and wherein the coefficient control block shapes the response of the adaptive equalization filter in conformity with the secondary path estimate and a delay corrected error, wherein the delay corrected error is based on a difference between the error microphone signal and a delayed source audio signal.

33. The integrated circuit of claim 32, wherein the one or more processing circuits implement a second coefficient control block that shapes the response of the secondary path estimate filter in conformity with the source audio signal and a playback corrected error by adapting the response of the secondary path estimate filter to minimize the playback corrected error, wherein the playback corrected error is based on a difference between the error microphone signal and the secondary path estimate.

34. The integrated circuit of claim 32, wherein a number of coefficients of the coefficient control block is selected such that a magnitude of the response of the adaptive equalization filter corresponding to a frequency in which the response of the secondary path estimate filter is substantially zero is limited below a predetermined maximum.

35. The integrated circuit of claim 32, wherein the one or more processing circuits implement a noise injection portion for injecting respective noise signals into the secondary path estimate and the delay corrected error in order to bias, to below a predetermined maximum, a magnitude of the response of the adaptive equalization filter corresponding to a frequency in which the response of the secondary path estimate filter is substantially zero.

36. The integrated circuit of claim 29, wherein the one or more processing circuits disable the response of the adaptive playback equalization system from adapting responsive to at least one of:
a determination that a spectral density of the source audio signal is lesser than a minimum spectral density;
a determination that the transducer has been removed from a proximity of an ear of the listener;
a determination that a magnitude of the output audio signal is within a predetermined threshold of a magnitude of a power supply for driving the output audio signal; and
a determination that a displacement of the transducer is such that its displacement as a function of the output audio signal is substantially nonlinear.

37. The integrated circuit of claim 29, further comprising a reference microphone input for receiving a reference microphone signal indicative of the ambient audio sounds, wherein the noise cancellation system further comprises:
an adaptive filter having a response that generates the anti-noise signal from the reference microphone signal to reduce the presence of the ambient audio sounds heard by the listener; and
a coefficient control block that shapes the response of the adaptive filter in conformity with the error microphone signal and the reference microphone signal by adapting the response of the adaptive filter to minimize the ambient audio sounds in the error microphone signal.

38. The integrated circuit of claim 29, further comprising a reference microphone input for receiving a reference microphone signal indicative of the ambient audio sounds, wherein the noise cancellation system further comprises:
a filter having a response that generates the anti-noise signal from the reference microphone signal to reduce the presence of the ambient audio sounds heard by the listener;
a secondary path estimate adaptive filter for modeling an electro-acoustical path of the source audio signal and having a response that generates a secondary path estimate from the equalized source audio signal; and
a coefficient control block that shapes the response of the secondary path estimate adaptive filter in conformity with the equalized source audio signal and a playback corrected error by adapting the response of the secondary path estimate adaptive filter to minimize the playback corrected error, wherein the playback corrected error is based on a difference between the error microphone signal and the secondary path estimate.

39. The integrated circuit of claim 38, wherein the one or more processing circuits are configured to adapt the response of the secondary path estimate adaptive filter prior to adapting the response of the adaptive playback equalization system.

40. The integrated circuit of claim 39, wherein the one or more processing circuits are configured to alternate adaptation of the secondary path estimate adaptive filter and the response of the adaptive playback equalization system.

41. The integrated circuit of claim 38, wherein the one or more processing circuits are configured to adapt the response of the adaptive playback equalization system only when the secondary path estimate adaptive filter is adapting.

42. The integrated circuit of claim 38, wherein the one or more processing circuits are configured to adapt the response of the adaptive playback equalization system at a rate slower than the rate of adaptation of the secondary path estimate adaptive filter.
